(19) United States
(12) Patent Application Publication
(10) Pub. No.: US 2013/0038458 A1
(43) Pub. Date: Feb. 14, 2013

(54) APPARATUS AND A METHOD FOR CAUSING A CHANGE IN THE STATE OF A HEADSET

(71) Applicants: Timo Toivola, Turku (FI); Osmo Knuuttila, Turku (FI)

(72) Inventors: Timo Toivola, Turku (FI); Osmo Knuuttila, Turku (FI)

(73) Assignee: NOKIA CORPORATION, Espoo (FI)

(21) Appl. No.: 13/642,074

(22) PCT Filed: Apr. 23, 2010
(86) PCT No.: PCT/FI2010/050332

§ 371 Date: Oct. 18, 2012

(51) Int. Cl. H04M 1/73

(52) U.S. Cl. 340/665

(57) ABSTRACT

An apparatus including a strain sensor configured to sense strain in a connecting part between a first part and a second part of a headset, and a circuitry earpiece configured to cause a change in the state of the headset in accordance with the sensed strain. A corresponding method.

### TECHNICAL FIELD

The present invention generally relates to apparatuses having a sensor attached to a headset and to controlling the headset according to the sensed information.

### BACKGROUND ART

Active headsets have recently become very popular. An active headset consumes power from a battery. The battery can be a primary cell inside the headset, a rechargeable cell inside the headset, or the headset may receive power from a battery in a supplying device, for example, a battery of a mobile phone.

A headset typically contains a switch by which the user can switch the headset on and off. While being “ON” the headset will consume power from the battery. When the battery becomes empty, the battery must be replaced or recharged before the headset can be used again.

### SUMMARY

According to a first example aspect of the invention there is provided an apparatus comprising:

a strain sensor configured to sense strain in a connecting part between a first part and a second part of a headset; and

a circuitry configured to cause a change in the state of the headset in accordance with the sensed strain.

In certain example embodiments, said causing a change in the state of the headset comprises deactivating or activating the headset. In other embodiments, said causing a change in the state of the headset comprises pausing a connection in the headset, and/or switching the headset or the connection into a standby mode, and/or switching the headset or the connection into a mode with a lowered power consumption, and/or transferring sounds or voice from the headset, after a delay, into an external speaker or similar. Said causing a change in the state of the headset may comprise switching the headset or its communication connection from an activated state or operational mode (such as turned on mode or connection mode) into a deactivated state or operational mode (such as turned off or standby mode).

In certain example embodiments, the strain sensor comprises a strain gauge whose electrical resistance changes upon deformation. The strain gauge may be used to control the headset, for example, to activate and/or deactivate the headset.

Based on sensed strain the apparatus may deduce whether the headset is worn by the user or whether it has been taken off, and for example, deactivate the headset accordingly.

In certain example embodiments, the apparatus is configured to detect a change in the strain via detecting a change in the electrical resistance of the strain sensor.

In certain example embodiments concerning deactivation of the headset, the deactivation comprises switching power off from the headset.

In certain example embodiments concerning deactivation of the headset, the deactivation comprises deactivating an active noise cancellation function.

In certain example embodiments, the circuitry is configured to cause the change in the state of the headset in accordance with a detected change in the sensed strain.

In certain example embodiments, the change leading to the change in the state of the headset is a change from a strained condition to a non-strained condition.

In certain example embodiments, the apparatus is configured to cause the change in the state of the headset only after an intentional predetermined delay has occurred after a detected change in the sensed strain.

In certain example embodiments, the first part and the second part are earpieces or end parts of the apparatus, and the connecting part is a spring or a spring-like member, such a headband or a neckband, to which the strain sensor is attached. In an example implementation the appropriate sensor elements of the strain sensor are located in the connecting part, whereas the logics of the strain sensor are located in one of the earpieces.

In certain example embodiments, the circuitry is an analog circuitry.

In certain example embodiments, the apparatus comprises a switch to activate the headset.

In certain example embodiments, the apparatus is an active headset. It may be a battery operated headset, that is, it may consume power from a battery. It may be a low power device. The apparatus may be an active noise cancellation headset and/or a headset for a communication device, such as a mobile handset or phone. The headset may be a wireless headset. It may be a Bluetooth headset or another short range communication headset. It may be a headband or a neckband model. Strain gauge resistors may be fixed to a headband or a neckband depending on the model.

In certain example embodiments, a strain gauge is integrated into a headset (or headphones). The strain gauge senses whether the headset is worn by the user or if it has been taken off. Once it is sensed that it has been taken off, after a certain delay time the headset will power off and stop draining battery. The delay is set long enough that simply momentarily moving the headset does not cause the headset to turn off. In example embodiments involving active noise cancellation headsets, deactivating an active noise cancellation function in the active noise cancellation headset may be implemented similarly.

According to a second example aspect of the invention there is provided a method comprising:

sensing strain with a strain sensor in a connecting part between a first part and a second part of a headset; and

causing a change in the state of the headset based on the sensed strain.

In certain example embodiments, said causing a change in the state of the headset comprises deactivating or activating the headset. In other embodiments, said causing a change in the state of the headset comprises pausing a connection in the headset, and/or switching the headset or the connection into a standby mode, and/or switching the headset or the connection into a mode with a lowered power consumption, and/or transferring sounds or voice from the headset, after a delay, into an external speaker or similar. Said causing a change in the state of the headset may comprise switching the headset or its communication connection from an activated state or operational mode (such as turned on mode or connection mode) into a deactivated state or operational mode (such as turned off or standby mode).

In certain example embodiments, it is detected by a headset with a strain gauge whether the headset is worn or if it is left unused.

In certain example embodiments, the method comprises detecting a change in the strain via detecting a change in the electrical resistance of the strain sensor.

In certain example embodiments concerning deactivation of the headset, the deactivation comprises switching power off from the headset.

In certain example embodiments concerning deactivation of the headset, the deactivation comprises deactivating an active noise cancellation function.

In certain example embodiments, the method comprises causing the change in the state of the headset based on a detected change in the sensed strain.

In certain example embodiments, the method comprises causing the change in the state of the headset based on a detected change from a strained condition to a non-strained condition.

In certain example embodiments, the method comprises causing the change in the state of the headset only after an intentional predetermined delay has occurred after a detected change in the sensed strain.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well. Any appropriate combinations of the embodiments may be formed.

### BRIEF DESCRIPTION OF THE DRAWINGS

The invention will be described, by way of example only, with reference to the accompanying drawings, in which:

FIG. 1 shows a schematic drawing of an apparatus in operation in accordance with an example embodiment;

FIG. 2 is a schematic drawing showing the apparatus of FIG. 1 in more detail in accordance with an example embodiment;

FIG. 3 shows a schematic drawing of an apparatus in accordance with another example embodiment; and

FIG. 4 shows an example flow chart of a method in accordance with an example embodiment.

### DETAILED DESCRIPTION

In the following description, like numbers denote like elements.

It should be noted that although the example embodiments presented in the following mainly focus to deactivating a headset based on information sensed by a strain sensor, this is not to be considered limitative. The invention should therefore not be restricted to the deactivating embodiments only, but should be understood to cover also other embodiments, for example embodiments in which any other change in the state of the headset is caused based on the sensed information.

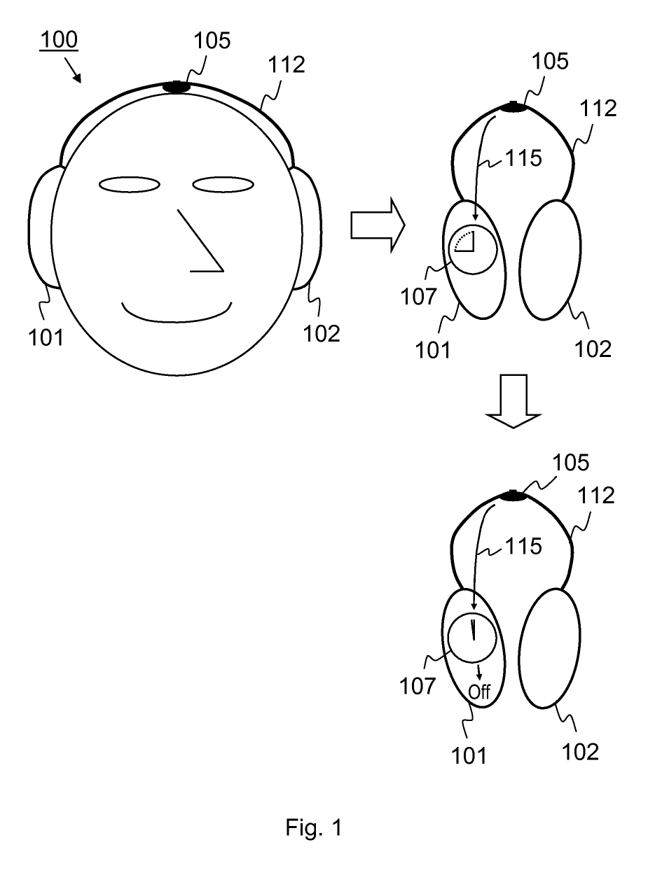

FIG. 1 shows a schematic drawing of an apparatus in operation in accordance with an example embodiment. The headset 100 comprises a first part or earpiece 101, a second part or earpiece 102 and a connecting part or headband 112 connecting the earpieces 101, 102. The headband 112 comprises a curved spring or spring-like member which is configured to be, due to its shape, in a continuous tension when the user is wearing the headset 100 on her/his head. The spring or spring-like member may be hidden below an outer (or protecting) surface of the headband 112. The earpieces 101, 102 are tightly pressed against the head of the user due to the continuous tension (see the top left drawing of FIG. 1 where the headset is in a “Turned On” or “Activated” state or status).

The headset 100 comprises a strain sensor 105 integrated to the headset. In an example implementation, an appropriate sensor element (or sensor elements) of the strain sensor 105 are integrated in the headband 112, whereas the logics of the strain sensor 105 are located in one of the earpieces 101, 102. In an example embodiment the strain sensor 105 comprises a strain gauge. In an example embodiment, the strain gauge is a film-like component. The strain gauge or a strain gauge film in an example implementation is attached to a bending surface of the spring or spring-like member of the headband 112. The strain sensor 105 is thereby protected inside the headband 112 (below the protecting surface of the headband 112). In an example implementation, the strain sensor 105 is fixed to the spring or spring-like member by glue.

In an alternative embodiment, instead of having the logics of the strain sensor 105 merely in one of the earpieces 101, 102, the logics or part of it is placed with the strain sensor 105, such as the strain gauge. It may comprise an appropriate switching driver unit or similar.

The strain sensor 105, such as the strain gauge, in an example embodiment forms a component of its own. In one implementation it comprises an on/off switch with a sheet, a flex, some appropriate components and wires.

In the top right drawing of FIG. 1 the user has taken the headset 100 off from his/her head. The headset 100 is in a “Taken Off” state.

In an example embodiment, the strain sensor 105 is configured to obtain information about, for example, whether the headset 100 is worn by the user or not. According to an example embodiment of the invention, when the headset 100 is worn by the user, the headset is in a strained condition. This strain is detected by the strain sensor 105. When the headset 100 is not worn by the user, the headset is in a less-strained or non-strained condition. This is, again, detected by the strain sensor 105.

According to an example embodiment, once the headset 100 enters the “Taken Off” state, a delay circuit illustrated by the timer 107 shown in the top right drawing of FIG. 1 is configured to produce a predetermined delay before a deactivation signal is passed to a deactivation switch (not shown in FIG. 1) of the headset 100. In this way, unintentional deactivation of the headset 100 may be prevented. The deactivation signal is depicted by the “Off” signal in the bottom right drawing of FIG. 1. The headset enters a “Turned Off” state. Communication between the sensor element of the strain sensor 105 in the headband 112 and electronics in the earpiece 101 is depicted by the arrow 115. In practice, there may be conductors between the sensor element(s) and the earpiece 101. The conductors may have been hidden below the protecting surface of the headband 112.

Once the headset 100 deactivates, the power consumption of the headset 100 finishes or reduces compared to an active state.

In embodiments concerning deactivation of the headset, deactivation of the headset may comprise for example switching power off from the headset 100 or deactivating only a (power consuming) function of the headset 100. The deactivation may comprise closing a connection, such as a Bluetooth connection in a Bluetooth headset, or entering a standby mode. In the event the headset is, for example, an active noise cancellation headset, the deactivation of the headset may comprise deactivation of the noise cancellation function only. Alternatively, the deactivation may comprise switching the power of the headset off entirely. In other embodiments, based on the sensed strain, the sounds or voice from the headset is transferred, after a delay, into an external speaker or similar. In certain example embodiments, based on the sensed strain, the headset is switched from a first operating mode into a second operating mode, the second operating mode consuming less power than the first operating mode.

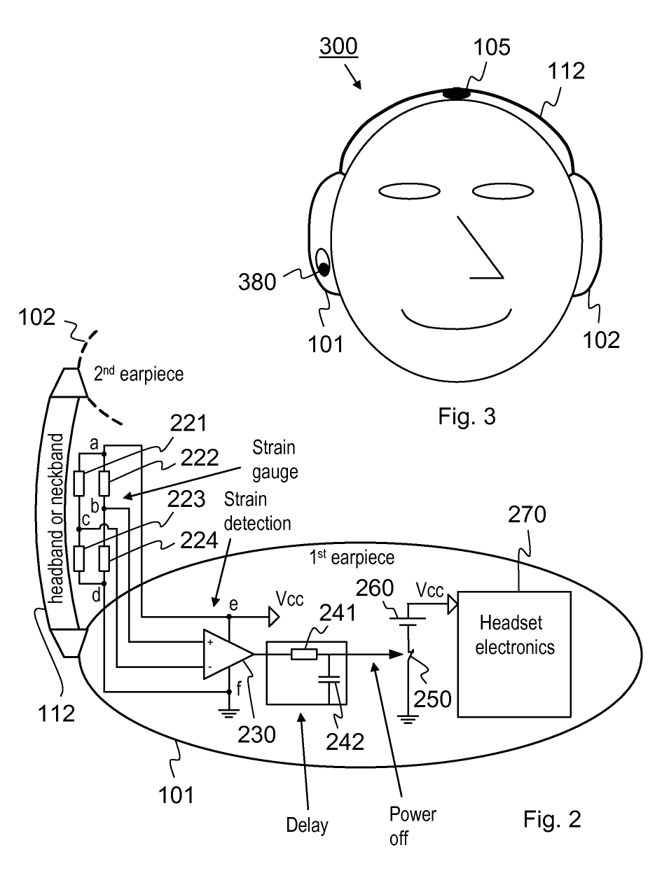

FIG. 2 shows the strain sensor (here: strain gauge) and power off switching in more detail in accordance with an example embodiment. A sensor element comprising strain gauge resistors 221-224 as a resistor network (or part of the network) is integrated into the headband (or neckband) 112 of the headset 100. Different parts of the resistor network are connected to a comparator circuit 230. Point (c) between resistors 221 and 223 is connected to a first input of the comparator circuit 230, and point (b) between resistors 222 and 224 is connected to a second input of the comparator circuit 230. Points (a) and (e) reside in the electrical potential Vcc, whereas points (d) and (f) have been connected to the ground.

As the spring or spring-like element, to which the strain gauge with resistors 221-224 is tightly attached, is deformed due to experienced tension, the strain gauge is also deformed causing the electrical resistance of the resistors 221-224 to change. This will be detected by the comparator circuit 230, which will provide an output signal to a delay circuit comprising a delay arrangement implemented for example by a resistor-capacitor circuit, such as a resistor 241 and a capacitor 242.

The delay circuit controls a power off switch 250 with an output signal (Power off signal). The switch can be a FET transistor or similar. When the headset 100 is worn by the user, the continuous tension experienced by the strain gauge keeps the power off signal low. A headset battery 260 feeds power to headset electronics 270. When the power off signal is low, the power off switch 250 remains closed and the headset electronics 270 powered on. When there is a change in the tension (for example the user takes the headset 100 off her/his head), this is detected by the comparator circuit 230, the power off signal becomes high after a delay produced by the delay circuit, and the power off switch 250 opens deactivating the power supply from the battery 260 to the headset electronics 270. In alternative embodiments, the switch 250 is similarly used to cause any other appropriate change in the state of the headset.

In certain example embodiments, if the headset is taken back in use within the delay time, the delayed deactivation is slowly reversed by the circuitry, and the headset continues its normal function. In alternative embodiments in which the comparator function and/or the delay function is implemented for example by a processor in the headset, more logic can be implemented by the processor. For example, a short movement on the headband or neckband can be programmed to reset the delay time.

FIG. 3 shows a schematic drawing of an apparatus in accordance with another example embodiment. The apparatus 300 shown in FIG. 3 otherwise corresponds to the apparatus 100 described in the preceding except that the apparatus 300 additionally comprises a power switch 380 with the aid of which the user can activate (for example, to switch the power on again) the headset after the headset has been deactivated. The switch may be, for example, a button or a magnetic slide switch. It may be of a returning type. Once the user has activated the headset, the delay circuit in an embodiment keeps the headset 300 powered on long enough that the user has enough time to put the headset around her/his head.

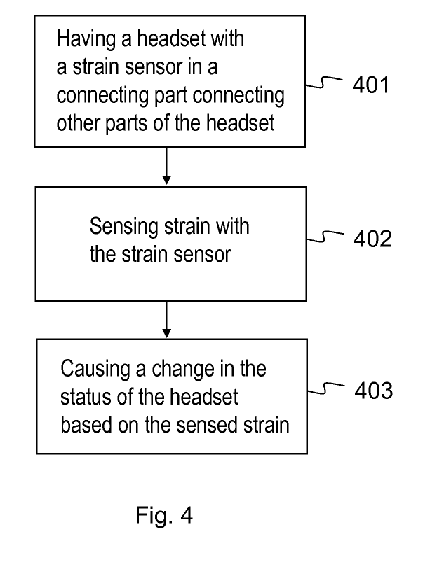

FIG. 4 shows an example flow chart of a method in accordance with an example embodiment. The connecting part between a first and second part of a headset comprises a strain sensor (block 401) which is used in accordance with blocks 402 and 403. The strain sensor or strain gauge may have been fixed to a spring or spring-like member of the connecting part, for example, by glue. In block 402, strain in the strain sensor is sensed by the strain sensor. And, in block 403, a change of the state of the headset is caused based on the sensed strain. The example method presented in the foregoing is an example only. In another example method, the method may comprise causing the change of the state of the headset only after a predetermined delay has occurred after a detected change in the sensed strain.

One or more of the embodiments of the invention may provide one or more of the following technical effects. A power off function on active headsets by the use of a strain gauge may be implemented. A simple and economic hardware solution may be achieved. An apparatus may be realized without expensive conductive materials. Simple analog models providing a deactivation function without any microcontrollers or microprocessors may be provided. Only a simple analog circuit is needed for strain detection and to activate a power off switch.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. An apparatus comprising:
a strain sensor configured to sense strain in a connecting part between a first part and a second part of a headset; and
a circuitry configured to cause a change in the state of the headset in accordance with the sensed strain.

2. An apparatus according to claim 1, wherein the strain sensor comprises a strain gauge whose electrical resistance is configured to change upon deformation.

3. An apparatus according to claim 1, wherein the apparatus is configured to detect a change in the strain via detecting a change in the electrical resistance of the strain sensor.

4. An apparatus according to claim 1, wherein said causing a change in the state of the headset comprises deactivating the headset.

5. An apparatus according to claim 4, wherein the deactivation comprises switching power off from the headset.

6. An apparatus according to claim 4, wherein the deactivation comprises deactivating an active noise cancellation function.

7. An apparatus according to claim 1, wherein the circuitry is configured to cause the change in the state of the headset in accordance with a detected change in the sensed strain.

8. An apparatus according to claim 7, wherein the change leading to the change in the state of the headset is a change from a strained condition to a non-strained condition.

9. An apparatus according to claim 1, wherein the apparatus is configured to cause the change in the state of the headset only after a predetermined delay has occurred after a detected change in the sensed strain.

10. An apparatus according to claim 1, wherein the first part and the second part are earpieces, and the connecting part is a spring-like member, such a headband or a neckband, to which the strain sensor is attached.

11. An apparatus according to claim 1, wherein the circuitry is an analog circuitry.

12. An apparatus according to claim 1, wherein the apparatus comprises a switch to activate the headset.

13. An apparatus according to claim 1, wherein the apparatus is an active noise cancellation headset, a headset for a communication device, a Bluetooth headset, or other wireless headset.

14. A method comprising:
sensing strain with a strain sensor in a connecting part between a first part and a second part of a headset; and
causing a change in the state of the headset based on the sensed strain.

15. A method according to claim 14, comprising:
detecting a change in the strain via detecting a change in the electrical resistance of the strain sensor.

16. A method according to claim 14 or 1-5, wherein said causing a change in the state of the headset comprises deactivating the headset.

17. A method according to claim 16, wherein the deactivation comprises switching power off from the headset.

18. A method according to claim 16, wherein the deactivation comprises deactivating an active noise cancellation function.

19. A method according to claim 14, comprising:
causing the change in the state of the headset based on a detected change in the sensed strain.

20. A method according to claim 19, comprising:
causing the change in the state of the headset based on a detected change from a strained condition to a non-strained condition.

21. A method according to claim 14, comprising:
causing the change in the state of the headset only after a predetermined delay has occurred after a detected change in the sensed strain.

22. An apparatus comprising:
means configured to sense strain in a connecting part between a first part and a second part of a headset; and
means configured to cause a change in the state of the headset in accordance with the sensed strain.
